(19) United States
(12) Patent Application Publication
(10) Pub. No.: US 2012/0282481 A1
(43) Pub. Date: Nov. 8, 2012

(54) SLIDING MEMBER

(76) Inventors: Mikihito Yasui, Inuyama (JP); Satoshi Takayanagi, Inuyama (JP); Hiroyuki Asakura, Inuyama (JP)

(21) Appl. No.: 13/519,257

(22) PCT Filed: Feb. 4, 2011
(86) PCT No.: PCT/JP2011/052396

§ 371 Date: Jun. 26, 2012

(30) Foreign Application Priority Data
Feb. 5, 2010 (JP) 2010-024198

(51) Int. Cl. F16C 33/12

(52) U.S. Cl. 428/555; 428/554; 428/323

(57) ABSTRACT

Disclosed is a sliding member (11) that has a base section (12) and an overlay layer (13) provided on the base section (12). The overlay layer (13) has Bi or a Bi alloy as the base, and contains Sn or an Sn alloy. The average particle size of Sn-based particles (15) distributed within the overlay layer (13) is no more than 5% of the average particle size of Bi-based particles (14) distributed within the overlay layer (13).

### TECHNICAL FIELD

The present invention relates to a sliding member having an overlay layer which is formed by adding Sn or an Sn-alloy to Bi or a Bi-alloy.

### BACKGROUND ART

A sliding bearing which is a typical example of a sliding member and is used in an internal combustion engine of an automobile or the like is a structure in which a bearing alloy layer composed of a Cu alloy or an Al-alloy is provided on a back metal layer composed of steel, for example. An overlay layer is usually provided on a sliding surface of the sliding bearing in order to improve conformability and anti-seizure property.

An overlay layer has been conventionally formed of a soft Pb alloy. Further, in recent years, it has been proposed to use Bi as an alternative material of Pb which has a large environmental load. However, since Bi is brittle, the conformability and anti-seizure property of sliding bearings having overlays composed of Bi are generally lower than those of the sliding bearings having overlay layers formed of a Pb alloy. Therefore, as described in Patent Literature 1, for example, an overlay layer is formed by adding one or more elements selected from Sn, In and Ag, to Bi, and the conformability and anti-seizure property of the overlay layer are improved.

### CITATION LIST

### Patent Literature

Patent Literature 1: JP-A-11-50296

### SUMMARY OF INVENTION

### Technical Problem

When an overlay layer is formed by adding Sn or an Sn-alloy to Bi or a Bi-alloy, an overlay layer 1 has a structure in which Bi-based particles 2 and Sn-based particles 3 coexist, as shown in FIG. 5. The Bi-based particle 2 is a crystal grain formed of Bi or a Bi-alloy, and the Sn-based particle 3 is a crystal grain formed of Sn or an Sn-alloy. The Sn-based particle 3 is present within the Bi-based particle 2 and on the a grain boundary of the Bi-based particle 2. Here, Sn has a melting point lower than that of Bi, and therefore, as compared with the Bi-based particle 2, the Sn-based particle 3 is easily melted by frictional heat which is generated when a counterpart sliding member such as a crankshaft slides in contact with the sliding surface of the sliding bearing. Therefore, elevation of the temperature of the sliding bearing is suppressed by melting of the Sn-based particle 3. More specifically, a latent heat effect that the frictional heat is absorbed by melting of the Sn-based particles is obtained, and the anti-seizure property of the sliding bearing can be improved.

Now, when the Sn-based particles 3 are melted and flow away, recessed spots are formed in the places where the Sn-based particles 3 were present. The larger the sizes of the Sn-based particles 3 are, the larger the sizes of the recessed spots on the sliding surface become. Generally, the lubricant such as lubricating oil is interposed in a film shape between the counterpart member and the sliding surface at the time of sliding. However, if a large recessed spot is formed in the sliding surface, the lubricating film easily breaks. Thus, it is feared that the counterpart member is brought into contact with the sliding surface of the sliding bearing without the lubricant interposed therebetween, resulting in seizure.

The sizes of the Sn-based particles in the overlay layer have not been focused on so far, and the literature which clearly describes it cannot be found. However, the average particle size of the Sn-based particles in the actual sliding members is approximately 0.15 μm.

The present invention is made under the technical background as described above. It is an object of the present invention to provide a sliding member that has an overlay layer which is formed by adding Sn or an Sn-alloy to Bi or a Bi-alloy, and is excellent in anti-seizure property.

### Solution to Problem

The present inventor considered that anti-seizure property can be improved by downsizing the recessed spots, which are formed after Sn-based particles are melted. And, the present inventor focused on the sizes of the Sn-based particles within the overlay layer, and earnestly repeated tests. As a result, the present inventor has confirmed that a sliding member having extremely favorable anti-seizure property can be obtained if the sizes of the Sn-based particles are within a predetermined range even where the amount of Sn in the overlay layer in which Sn or an Sn-alloy is included in Bi or a Bi-alloy is the same.

The present inventors have reached the present invention based on the understanding as above.

A sliding member of the present invention includes a base section, and an overlay layer provided on the base section and formed by adding Sn or an Sn-alloy to Bi or a Bi-alloy, and is characterized in that the overlay layer includes a base constituted of Bi-based particles composed of Bi or a Bi-alloy, and Sn-based particles dispersed in the base and composed of Sn or an Sn-alloy, and an average particle size of the Sn-based particles distributed within the overlay layer is not more than 5% of an average particle size of the Bi-based particles distributed within the overlay layer.

Here, the “base section” mentioned in the present description means a structure which is located on the side where the overlay layer is provided. For example, when a bearing alloy layer is provided on a back metal layer, and an intermediate layer as an adhesion layer is provided between the bearing alloy layer and the overlay layer, the back metal layer, the bearing alloy layer and the intermediate layer correspond to the base section. In addition, when the bearing alloy layer is provided on the back metal layer, and the overlay layer is provided on the bearing alloy layer, the back metal layer and the bearing alloy layer correspond to the base section. Further, when the overlay layer is provided on the back metal layer, the back metal layer corresponds to the base section. The aforesaid bearing alloy layer may be made of an Al-based bearing alloy, a Cu-based bearing alloy or a bearing alloy with another metal as a main component. The aforesaid intermediate layer is formed of a material which easily bonds with both the component of the bearing alloy layer and the component of the overlay layer, for example, Ag, an Ag-alloy, Co, a Co-alloy, Cu, a Cu-alloy or the like.

According to one embodiment of the sliding member of the present invention, X mass % that is a proportion of the Sn included in the overlay layer satisfies 0<X≦10, and more preferably 0.1≦X≦7.

In the present invention, it is essential that Sn is contained in the overlay layer. Further, when the Sn included in the overlay layer is not more than 10 mass %, the Sn-based particles in the overlay layer are easily dispersed and distributed. More specifically, in the present invention, the Sn-based particles can be restrained from becoming large particle sizes in the overlay layer, and the Sn-based particles with the average particle size of not more than 5% can be reliably obtained in the overlay layer.

According to another embodiment of the sliding member of the present invention, Cu is included in the overlay layer, and Y mass % that is a proportion of the Cu included in the overlay layer satisfies 0<Y≦5, more preferably 0.1≦Y≦2.

Cu combines with Sn to form a relatively hard Sn—Cu compound. The Sn—Cu compound has the effect of scraping off the adhered material adhering to a counterpart member, and therefore, the anti-seizure property of the sliding member is much more improved.

When Cu is contained in the overlay layer, the aforesaid effect is obtained. Further, when Cu contained in the overlay layer is not more than 5 mass %, the overlay layer does not become too hard, and favorable anti-seizure property is obtained.

According to another embodiment of the sliding member of the present invention, a number of the Sn-based particles distributed in the overlay layer are not less than five times as large as a number of the Bi-based particles distributed in the overlay layer.

Even when the content of the Sn-based particles which are distributed in the overlay layer is the same, as the number of the Sn-based particles distributed in the overlay layer is made larger, the volume per one particle of Sn-based particle can be made smaller. In the present invention, the number of the Sn-based particles distributed in the overlay layer is set to be not less than five times as large as the number of Bi-based particles distributed in the overlay layer. By this, the average particle size of the Sn-based particles distributed in the overlay layer more reliably becomes not more than 5% of the average particle size of the Bi-based particles, and the Sn-based particles are homogeneously dispersed in the overlay layer.

According to the aforesaid constitution, the Sn-based particles are homogeneously dispersed and distributed in the sliding surface of the overlay layer, whereby, the Sn-based particles are easily distributed more minutely, and recessed spots which are formed after melting of the Sn-based particles become small. Accordingly, a lubricating film can be more easily kept on the overlay layer. As a result, the sliding member has excellent anti-seizure property. Furthermore, even if the overlay layer abrades, a similar melting effect of the Sn-based particles can be exerted. Thereby, elevation of the temperature of the sliding member is stably suppressed, and the sliding member shows excellent anti-seizure property.

The overlay layer is an alloy material formed by adding Sn or an Sn-alloy to Bi or a Bi-alloy. The overlay layer is formed of a base constituted of Bi-based particles composed of Bi or a Bi-alloy, and Sn-based particles dispersed in the base and composed of Sn or an Sn-alloy. The Bi-based particles are crystal grains formed of Bi or a Bi-alloy, and the Sn-based particles are crystal grains formed of Sn or an Sn-alloy.

The components of the base section and the overlay layer may include the components other than those described above, and may include incidental impurities.

According to the aforesaid constitution, the Sn-based particles are mainly formed of Sn having a melting point lower than Bi, and therefore, are melted more easily than the Bi-based particles. Accordingly, the Sn-based particles are melted more easily than the Bi-based particles by the frictional heat which occurs when the counterpart member to be a sliding partner such as a crankshaft slides on the sliding surface of the sliding member. As a result, elevation of the temperature of the sliding member is suppressed by the melting of the Sn-based particles.

In the present invention, the Sn-based particles distributed in the overlay layer are made very fine. More specifically, the average particle size of the Sn-based particles is made not more than 5% of the average particle size of the Bi-based particles.

The “particle size” mentioned in the present invention means the diameter of the minimum circumcircle which is in contact with the outer edge of the crystal grain. Further, the “average particle size” mentioned in the present invention means the average value of the particle sizes of the particles distributed in a predetermined area, for example, 25 μm² in the cross-section of the overlay layer. The “particle size” and the “average particles size” are obtained with respect to the Bi-based particles and the Sn-based particles respectively.

For example, in the present invention, the Bi-based particles with the average particle size of 1 μm and the Sn-based particles with the average particle size of 0.01 μm are distributed in the overlay layer. In this case, the average particle size of the Sn-based particles is 1% of the average particle size of the Bi-based particles.

According to the aforesaid constitution, when the Sn-based particles distributed in the sliding surface of the overlay layer are melted, and the Sn-based particles flow away, the recessed spots in the same shapes as the Sn-based particles before being melted are formed in the places where the Sn-based particles were present.

In the present invention, the particle sizes of the Sn-based particles are not more than 5% of the average particle size of the Bi-based particles. Therefore, the shapes of the recessed spots are also the same as the outer shapes of the Sn-based particles before being melted, and are very fine. Accordingly, the lubricant such as a lubricating oil which is supplied to the sliding surface of the overlay layer easily fills the recessed spots, and the film of the lubricant (hereinafter, called a lubricating film) formed on the overlay layer is easily kept. As a result, the counterpart member is restrained from hitting the sliding member without a lubricant interposed therebetween, and the sliding member has excellent anti-seizure property. The average particle size of the Sn-based particles is preferably not less than 0.2% to not more than 4.3% of the average particle size of the Bi-based particles.

Here, the present inventor has confirmed that when the overlayer in which Sn or an Sn-alloy is contained in Bi or a Bi-alloy is provided on the base section by Bi-electroplating containing Sn, the Sn-based particle contained in the overlay layer become very fine by performing Bi-electroplating with generating minute coarseness and fineness of the current density on the surface of the base section. More specifically, the present inventor has found out that very fine Sn-based particles can be dispersed and distributed in the overlay layer as described above, by supplying micro nano-bubbles which are minute air bobbles to the surface of the base section and by generating minute coarseness and fineness of the current density on the surface of the base section, at the time of performing Bi-electroplating for providing the overlay layer on the base section. The diameters of the micro nano-bubbles are preferably 100 nm to 500 nm. As for the generation method of micro nano-bubbles, an ejector type, a cavitation type, a swirl-type, a pressure dissolution type, an ultrasonic using type, a micropore type and the like can be adopted. The method for making the Sn-based particles very fine is not limited to the above description.

### BRIEF DESCRIPTION OF DRAWINGS

FIG. 1 is a sectional view schematically showing an overlay layer in a sliding member of the present invention.

FIG. 2 is a sectional view of a sliding bearing according to an example of the present invention.

FIG. 3 is a view showing a particle shape in the overlay layer.

FIG. 4 is a view corresponding to FIG. 2 after Sn-based particles on a sliding surface of the overlay layer melt and flow.

FIG. 5 is a view showing a conventional example and corresponding to FIG. 1.

### DESCRIPTION OF EMBODIMENTS

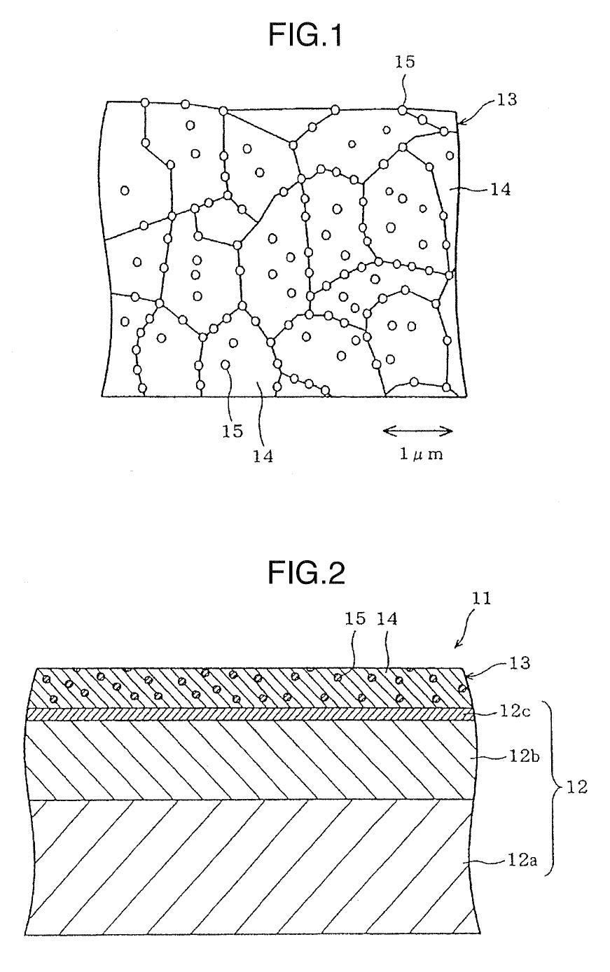

FIG. 2 is a sectional view showing a basic structure example of a sliding member such as a sliding bearing according to the present invention. A sliding member 11 shown in FIG. 2 has a structure in which an overlay layer 13 is provided on a base section 12.

The “base section” will be described with reference to FIG. 2 shown for illustrative purposes. When a bearing alloy layer 12b is provided on a back metal layer 12a, and an intermediate layer 12c as an adhesion layer is provided between the bearing alloy layer 12b and the overlay layer 13, the back metal layer 12a, the bearing alloy layer 12b and the intermediate layer 12c correspond to the base section 12. In addition, when the bearing alloy layer 12b is provided on the back metal layer 12a, and the overlay layer 13 is provided on the bearing alloy layer 12b, the back metal layer 12a and the bearing alloy layer 12b correspond to the base section 12. Further, when the overlay layer 13 is provided on the back metal layer 12a, the back metal layer 12a corresponds to the base section 12.

The bearing alloy layer 12b is a bearing alloy layer containing an Al-based bearing alloy, a Cu-based bearing alloy or another metal as a main component.

The intermediate layer 12c is formed of a material which is easily bonded to both the component of the bearing alloy layer 12b and the component of the overlay layer 13, for example, Ag, an Ag-alloy, Co, a Co-alloy, Cu, a Cu-alloy or the like.

The overlay layer 13 is an alloy material which is formed by adding Sn or an Sn-alloy to Bi or a Bi-alloy. The overlay layer 13 is formed by a base constituted of Bi-based particles composed of Bi or a Bi-alloy, and Sn-based particles composed of Sn or an Sn-alloy which are distributed in the base, as shown in FIG. 1. In FIG. 1, a top side is a sliding surface side. A Bi-based particle 14 is a crystal grain formed of Bi or a Bi-alloy, and an Sn-based particle 15 is a crystal grain formed of Sn or an Sn-alloy.

The components of the base section 12 and the overlay layer 13 may contain the components other than those described above, and may contain incidental impurities.

According to the constitution as above, the Sn-based particle 15 is mainly formed of Sn having a melting point lower than that of Bi, and therefore, is melted more easily than the Bi-based particle 14. Accordingly, the Sn-based particles 15 are melted more easily than the Bi-based particles 14 by the frictional heat which occurs when a counterpart member to be a sliding partner such as a crankshaft slides on the sliding surface of the sliding member 11. Accordingly, elevation of the temperature of the sliding member 11 is suppressed by melting of the Sn-based particles 15.

In the present invention, the Sn-based particles 15 which are distributed in the overlay layer 13 are made very fine. More specifically, the average particle size of the Sn-based particles 15 is made not more than 5% of the average particle size of the Bi-based particles 14.

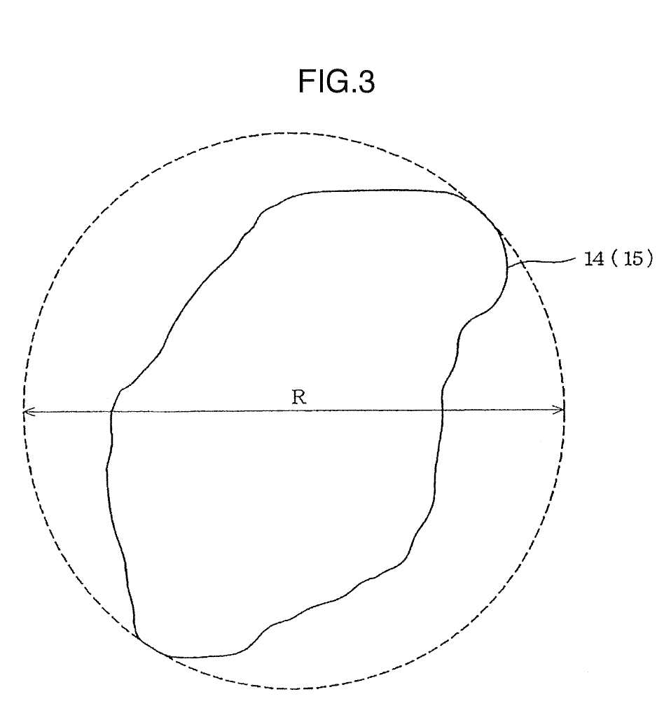

The “particle size” mentioned in the present invention means a diameter R of a minimum circumcircle which is in contact with an outer edge of a crystal grain as shown in FIG. 3. Further, the “average particle size” mentioned in the present invention means an average value of the particle sizes of the particles which are distributed in a predetermined area, for example, 25 μm² in the cross-section of the overlay layer 13. The “particle size” and the “average particle size” are obtained with respect to the Bi-based particles 14 and the Sn-based particles 15, respectively.

For example, in the present invention, the Bi-based particles 14 with the average particle size of 1 μm, and the Sn-based particles 15 with the average particle size of 0.01 μm are distributed in the overlay layer 13. In this case, the average particle size of the Sn-based particles 15 is 1% of the average particle size of the Bi-based particles 14.

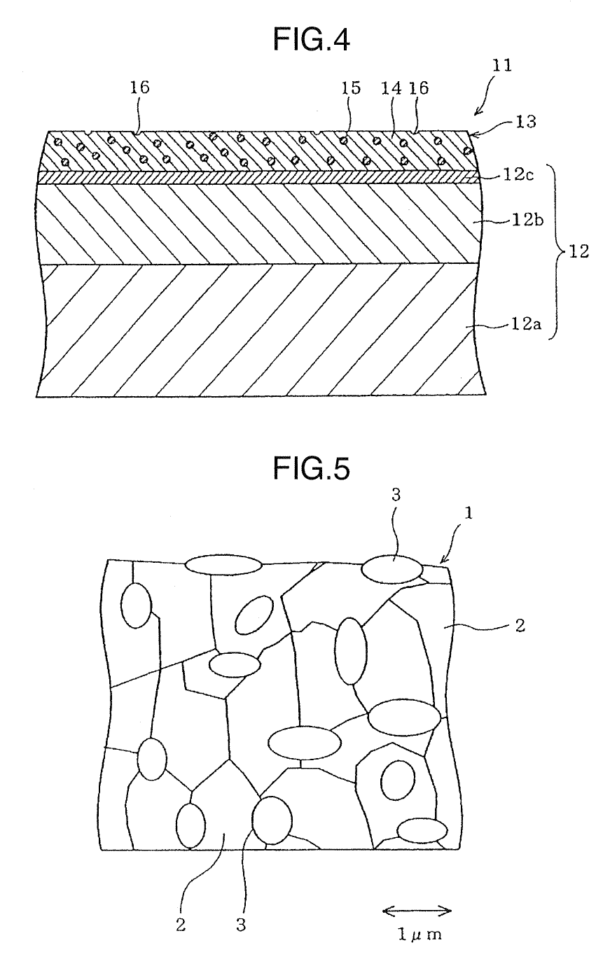

According to the aforesaid constitution, when the Sn-based particles 15 distributed in the sliding surface of the overlay layer 13 are melted, and the Sn-based particles 15 flow away, recessed spots 16 in the same shapes as the Sn-based particles 15 before being melted are formed in the places where the Sn-based particles 15 were present, as shown in FIG. 4.

In the present invention, the particle size of the Sn-based particle 15 is not more than 5% of the average particle size of the Bi-based particles 14. Therefore, the shape of the recessed spot 16 is the same as the outer shape of the Sn-based particle 15 before being melted, and is also very fine. Accordingly, a lubricant such as a lubricating oil which is supplied to the sliding surface of the overlay layer 18 easily fills the recessed spots 16, and a lubricant film which is formed on the overlay layer 13 is easily kept. As a result, the counterpart member is restrained from hitting the sliding member 11 without the lubricant interposed therebetween, and the sliding member 11 has excellent anti-seizure property. The average particle size of the Sn-based particles 15 is preferably not less than 0.2% to not more than 4.3% of the average particle size of the Bi-based particles 14.

In the present invention, it is essential that Sn is contained in the overlay layer 13. Further, when the Sn which is contained in the overlay layer 13 is not more than 10 mass %, the Sn-based particles 15 in the overlay layer 13 are easily dispersed and distributed. More specifically, in the present invention, the Sn-based particles can be restrained from becoming large particle sizes in the overlay layer 13, and the Sn-based particles 15 with the average particle size of not more than 5% can be reliably obtained in the overlay layer 13.

Cu combines with Sn to form a relatively hard Sn—Cu compound. The Sn—Cu compound has the effect of scraping off the adhered material that adhere to the counterpart member, and therefore, the anti-seizure property of the sliding member 11 is much more improved.

When Cu is contained in the overlay layer 13, the aforesaid effect is obtained. Further, when Cu contained in the overlay layer 13 is not more than 5 mass %, the overlay layer 13 does not become too hard, and favorable anti-seizure property is obtained.

Even when the content of the Sn-based particles which are distributed in the overlay layer is the same, as the number of Sn-based particles distributed in the overlay layer is made larger, the volume per one particle of the Sn-based particles can be made smaller. In the present invention, the number of the Sn-based particles 15 which are distributed in the overlay layer 13 is set to be not less than five times as large as the number of the Bi-based particles 14 which are distributed in the overlay layer 13. By this, the average particle size of the Sn-based particles 15 which are distributed in the overlay layer 13 becomes not more than 5% of the average particle size of the Bi-based particles 14 more reliably, and the Sn-based particles 15 are homogenously dispersed and distributed in the overlay layer 13.

According to the aforesaid constitution, the Sn-based particles 15 are homogeneously dispersed and distributed in the sliding surface of the overlay layer 13, whereby the Sn-based particles 15 are easily distributed more minutely, and the recessed spots 16 which are formed after melting of the Sn-based particles 15 become small. Accordingly, the lubricating film can be more easily kept on the overlay layer 13. As a result, the sliding member 11 has excellent anti-seizure property. Furthermore, even if the overlay layer 13 abrades, a similar melting effect of the Sn-based particles 15 can be exerted. Thereby, elevation of the temperature of the sliding member 11 is stably restrained, and the sliding member 11 shows excellent anti-seizure property.

Here, the present inventors have confirmed that when the overlay layer 13 in which Sn or an Sn-alloy is contained in Bi or a Bi-alloy is provided on the base section 12 by Bi-electroplating containing Sn, the Sn-based particles 15 contained in the overlay layer 13 become very fine by performing Bi-electroplating with generating minute coarseness and fineness of a current density on the surface of the base section 12. More specifically, the present inventor has found out that very fine Sn-based particles 15 can be dispersed and distributed in the overlay layer 13 as described above, by supplying micro nano-bubbles which are minute air bubbles to the surface of the base section 12 and by generating minute coarseness and fineness of the current density on the surface of the base section 12, at the time of applying Bi-electroplating to provide the overlay layer 13 on the base section 12. The diameters of the micro nano-bubbles are preferably 100 nm to 500 nm. As for the generating method of the micro nano-bubbles, an ejector type, a cavitation type, a swirl-type, a pressure dissolving type, an ultrasonic using type, a micropore type and the like can be adopted. The method for making the Sn-based particles 15 very fine is not limited to the above description.

Next, a test example of the sliding member of the present invention will be described.

In general, a sliding bearing which is a sliding member is obtained by providing an overlay layer on a base section which is constituted by providing a bearing alloy layer which is formed of a Cu-alloy or an Al-alloy on a back metal layer of steel, and by providing an intermediate layer on the bearing alloy layer as necessary. The sliding bearing which is the sliding member of the present invention is obtained as follows.

Further, in order to confirm the effect of the sliding bearing of the present invention, the samples shown in Table 1 (the present invention examples 1 to 12 and comparative examples 1 to 3 in Table 1) were prepared.

TABLE 1

| | | AVERAGE | | | | | |
|---|---|---|---|---|---|---|---|
| | | PARTICLE | | | | | |
| | | SIZE OF Sn- | | | | | |
| | | BASED | OVERLAY LAYER | | | | SEIZURE |
| | | PARTICLES | Bi | Sn | Cu | INTERMEDIATE | RESISTANCE |
| SAMPLE No. | | (%) | (mass %) | (mass %) | (mass %) | LAYER | (MPa) |
| PRESENT | 1 | 0.5 | BALANCE | 1 | | | 80 |
| INVENTION | 2 | 0.3 | BALANCE | 1 | 5.0 | | 80 |
| EXAMPLES | 3 | 1.7 | BALANCE | 3 | | | 80 |
| | 4 | 4.5 | BALANCE | 3 | | | 75 |
| | 5 | 1.5 | BALANCE | 3 | 1.0 | Ag | 85 |
| | 6 | 2.3 | BALANCE | 5 | 1.5 | | 85 |
| | 7 | 2.8 | BALANCE | 5 | | Cu | 80 |
| | 8 | 4.0 | BALANCE | 8 | | | 80 |
| | 9 | 3.8 | BALANCE | 8 | 1.2 | | 85 |
| | 10 | 4.0 | BALANCE | 10 | | Ag—Sn | 80 |
| | 11 | 3.9 | BALANCE | 10 | 0.8 | | 85 |
| | 12 | 3.7 | BALANCE | 13 | | | 80 |
| COMPARATIVE | 1 | 6.2 | BALANCE | 7 | | | 65 |
| EXAMPLES | 2 | 10.3 | BALANCE | 5 | | | 60 |
| | 3 | 15.1 | BALANCE | 15 | | | 50 |

First, the Cu-alloy bearing alloy layer 12b was lined on the steel back metal layer 12a to produce bimetal. Next, the bimetal was formed into a semi-cylindrical shape or a cylindrical shape to obtain a molded product. Next, boring was applied to the surface of the bearing alloy layer 12b of the molded product to finish the surface, and the surface was cleaned by electric degreasing and acid. Further, the intermediate layer 12c which was formed of any of Ag, Co, an Ag—Sn alloy was provided on the surface of the molded product in accordance with necessity, and the overlay layer 13 was provided on the molded product or the intermediate layer 12c by Bi-electroplating. The conditions of the Bi-electroplating are shown in Table 2. In adding Cu, use of 0.5 to 5 g/litter of basic copper carbonate is preferable.

Here, concerning the present invention examples 1 to 12 which correspond to the present invention, during the Bi-electroplating, micro nano-bubbles were generated in the plating solution by a micro nano-bubble device (not illustrated), and the micro nano-bubbles were supplied to the surfaces of the molded products (intermediate layers).

TABLE 2

| | | | |
|---|---|---|---|
| PLATING | Bi CONCENTRATION | 20-40 | g/litter |
| SOLUTION | Sn CONCENTRATION | 0.5-3 | g/litter |
| COMPOSITION | Cu CONCENTRATION | 0-5 | g/litter |
| | ORGANIC SULFONIC | 30-70 | g/litter |
| | ACID | | |

| | | |
|---|---|---|
| CURRENT DENSITY | 3-5 | A/dm² |
| PLATING BATH TEMPERATURE | 20-40° | C. |

| | |
|---|---|
| CURRENT DENSITY COARSENESS | USE MICRO NANO- |
| AND FINENESS GENERATING | BUBBLE GENERATING |
| MEANS | DEVICE |

By supplying micro nano-bubbles, minute coarseness and fineness of the current density were generated on the surface of the molded product (intermediate layer), and Sn-based particles were minutely precipitated around the Bi-based particles. As for the device which generates micro nano-bubbles, the device was used which applies high pressure to the spiral flow pass to shear the plating solution and air and mix them minutely. In the path in which the plating solution was circulated in the sequence of the plating tank, the pump, the filter and the plating tank, the device for generating micro nano-bubbles was provided between the filter and the plating tank.

The diameters of the micro nano-bubbles in the plating solution were measured by using a nano-particle size distribution device “SALD-7100” manufactured by Shimadzu Corporation. As the result of the measurement, not less than 80% of the air bubbles which are present in the plating solutions for forming the overlay layers used in production of the present invention examples 1 to 12 had the diameters of 100 nm to 500 nm.

According to the aforesaid manufacturing method, the present invention examples 1 to 12 were obtained. In the present invention examples 1 to 12, the difference in the sizes of the Sn-based particles is due to the levels of the coarseness and fineness of the current densities, that is, the supply amounts and the sizes of micro nano-bubbles.

Comparative examples 1 to 3 were obtained according to the manufacturing method similar to the present invention examples except that minute coarseness and fineness of the current density were not generated on the surfaces of the molded products.

The sizes of the Sn-based particles were measured by observing the cross-section of the overlay layer with an electron microscope or an ion microscope. Then, the numbers and the particle sizes of the respective Bi-based particles and the Sn-based particles which are distributed in 25 μm² were obtained, and the average particle size of each of them was calculated. Then, the average particle size of the Sn-based particles was divided by the average particle size of the Bi-based particles, and the resulting value was expressed in percentage in Table 1.

A seizure test was performed under the conditions shown in the following Table 3, with respect to the aforesaid respective samples.

TABLE 3

| | |
|---|---|
| TESTING MACHINE | SEIZURE TESTING MACHINE |
| NUMBER OF REVOLUTIONS | 7200 rpm |
| PERIPHERAL VELOCITY | 20 m/second |
| TEST LOAD | INCREASE BY 5 MPa EVERY |
| | 10 MINUTES |
| LUBRICATION TEMPERATURE | 100° C. |
| LUBRICATION AMOUNT | 150 ml/min |
| MATERIAL OF SHAFT | JIS S55C |
| EVALUATION METHOD | SPECIFIC LOAD WHEN |
| | BEARING BACK TEMPERATURE |
| | EXCEEDS 200° C. OR |
| | WHEN SHAFT DRIVING BELT |
| | SLIPS BY TORQUE CHANGE IS |
| | REGARDED AS SEIZURE LOAD |

Next, the result of the seizure test will be analyzed.

From comparison between the present invention examples 1 to 12 and comparative examples 1 to 3, it can be understood that the average particle size of the Sn-based particles is not more than 5% of the average particle size of the Bi-based particles in each of the present invention examples 1 to 12, and therefore, the present invention examples 1 to 12 are more excellent in anti-seizure property than comparative examples 1 to 3.

From the comparison between the present invention examples 1 to 11 and the present invention example 12, it can be understood that when Sn included in the overlay layer is not more than 10 mass %, the anti-seizure property is far more improved.

From the comparison between the present invention examples 5, 6, 9 and 11, and the present invention examples 3, 7, 8 and 10, it can be understood that when not more than 5 mass % of Cu is contained in the overlay layer, the anti-seizure property is far more improved.

Also, the cross-section of the overlay layer of each of the samples was observed with an electron microscope or an ion microscope, and the numbers of the respective Bi-based particles and the Sn-based particles which are distributed in 25 μm² was counted. As a result, the number of the Sn-based particles distributed in the overlay layer was not less than five times as large as the number of the Bi-based particles distributed in the overlay layer in each of the present invention examples 1 to 3 and 5 to 12, while it is not shown in Table 1. In each of the present invention examples 6, 9 and 11, the number of the Sn-based particles distributed in the overlay layer was not less than ten times as large as the number of Bi-based particles distributed in the overlay layer.

### INDUSTRIAL APPLICABILITY

The sliding member of the present invention is applied to a sliding bearing used in an internal combustion engine, and the like.

### REFERENCE SIGNS LIST

In the drawings, 11 designates a sliding member, 12 designates a base section, 12a designates a back metal layer (base section), 12b designates a bearing alloy layer (base section), 12c designates an intermediate layer (base section), 13 designates an overlay layer, 14 designates a Bi-based particle, and 15 designates an Sn-based particle.

1. A sliding member comprising
a base section, and
an overlay layer provided on the base section and formed by adding Sn or an Sn-alloy to Bi or a Bi-alloy,
wherein the overlay layer comprises a base constituted of Bi-based particles composed of Bi or a Bi-alloy, and Sn-based particles dispersed in the base and composed of Sn or an Sn-alloy, and
wherein an average particle size of the Sn-based particles distributed in the overlay layer is not more than 5% of an average particle size of the Bi-based particles distributed in the overlay layer.

2. The sliding member according to claim 1,
wherein X mass % that is a proportion of the Sn included in the overlay layer satisfies 0<X≦10.

3. The sliding member according to claim 1,
wherein the overlay layer comprises Cu, and
Y mass % that is a proportion of the Cu in the overlay layer satisfies 0<Y≦5.

4. The sliding member according to claim 2,
wherein the overlay layer comprises Cu, and
Y mass % that is a proportion of the Cu in the overlay layer satisfies 0<Y≦5.

5. The sliding member according to claim 1,
wherein a number of the Sn-based particles distributed in the overlay layer is not less than five times as large as a number of the Bi-based particles distributed in the overlay layer.

6. The sliding member according to claim 1,
wherein the base section comprises a back metal layer and a bearing alloy layer provided on the back metal layer.

7. The sliding member according to claim 6,
wherein the bearing alloy layer is formed of an Al-based bearing alloy or a Cu-based bearing alloy.

8. The sliding member according to claim 1,
wherein an intermediate layer is interposed between the back metal layer and the bearing alloy layer.

9. The sliding member according to claim 8,
wherein the intermediate layer is selected from the group consisting of Ag, an Ag-alloy, Co, a Co-alloy, Cu, and a Cu-alloy.

10. The sliding member according to claim 2,
wherein a number of the Sn-based particles distributed in the overlay layer is not less than five times as large as a number of the Bi-based particles distributed in the overlay layer.

11. The sliding member according to claim 3,
wherein a number of the Sn-based particles distributed in the overlay layer is not less than five times as large as a number of the Bi-based particles distributed in the overlay layer.

12. The sliding member according to claim 4,
wherein a number of the Sn-based particles distributed in the overlay layer is not less than five times as large as a number of the Bi-based particles distributed in the overlay layer.
